(19) United States
(12) Patent Application Publication
(10) Pub. No.: US 2006/0217948 A1
(43) Pub. Date: Sep. 28, 2006

(54) Component for a simulation tool

(75) Inventors: Denver Humphrey, Ballymena (GB); William Verner, Belfast (GB)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/086,231

(22) Filed: Mar. 23, 2005

(51) Int. Cl. G06F 17/50

(52) U.S. Cl. 703/14

(57) ABSTRACT

A component for a simulation tool, the component comprising means for defining a model of a circuit element, for example an inductor, capacitor or resistor. The defining means comprises a set of performance parameters, for example S-parameters, that define the performance of the circuit element over a range of frequencies. The parameter set is derived from the performance of the circuit element in a test environment, for example on a test substrate. The defining means further includes means for negating the effect on the parameter set of the test environment. The negating means is conveniently derived from a circuit model having a circuit topology derived from a circuit model of the test environment, but in which component values are negated in comparison with the corresponding component values of the test environment model.

### FIELD OF THE INVENTION

The present invention relates to modelling electrical circuit components, especially substrate mounted electrical circuit components.

### BACKGROUND

There are three commonly used passive electrical circuit components, or elements, namely resistors, inductors and capacitors. At low operational frequencies the behaviour of these components is well defined and very predictable. However as the operational frequency increases, their behaviour changes radically from the ideal case in such a way that they may no longer exhibit the desired characteristics.

It is known to provide an equivalent circuit model for modelling the behaviour of electrical circuit components over frequency. By way of example, a conventional intrinsic inductor circuit model in a simplistic form is shown in FIG. 1, generally indicated as 10. A model component 12 representing the inductance of the inductor is placed in a parallel RLC circuit 14 that predicts the self-resonant frequency of the inductor being modelled. The model 10 typically also includes a fixed resistance 15 and a frequency dependent resistance 17 representing losses. When the inductor being modelled is mounted or placed on a PCB or dielectric substrate, the self resonant frequency of the inductor changes due to parasitic effects of the dielectric material. This is illustrated in FIG. 2 which shows how the resonance characteristics of a component can vary depending on the substrate on which it is mounted.

Additional components can be added to the intrinsic circuit model to account for such parasitic effects. As a result, the resonant frequency of the model changes depending on substrate. An example of such a circuit model 110 is illustrated in FIG. 3, where a respective parallel RC circuit 16A, 16B has been added between the input and ground and between the output and ground, and a capacitance 18 has been added in parallel with the intrinsic model 10. However, such additional components need to be determined for every eventuality that may be encountered during use and this is a costly and time consuming exercise.

An additional problem with the conventional technique described above is that only the first resonance of the component is predicted - resonances appearing at higher frequencies are ignored. This is illustrated in FIG. 4 which shows a first frequency response 20 including a single resonant frequency F1′ as modelled by, say, the circuit model of FIG. 3, and an actual frequency response 22 for the modelled component including at least three further resonant frequencies F2, F3, F4. FIG. 5 shows a complex equivalent circuit model 210, which can be used to predict several resonant points or resonant frequencies. It will be seen that the number of components or elements in the model 210, and thus the numerical fitting for each substrate, has increased considerably in comparison with the circuit of FIG. 3. The effectiveness of the extended equivalent circuit model 210 is indicated in FIG. 6, in which the predicted response is indicated as 24 and the actual response is indicated as 26.

The limitations of conventional circuit modelling techniques for high frequency components will be apparent from the foregoing. It would be desirable to provide an equivalent circuit model and modelling method that is relatively simple to design and implement.

### SUMMARY OF THE INVENTION

Accordingly, a first aspect of the invention provides a component for a simulation tool, the component comprising means for defining a model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment.

In the preferred embodiment, said circuit element model comprises a topology of circuit components, said parameter set serving as a component of said circuit model topology. Conveniently, said parameter set comprises S-parameters.

Advantageously, said negating means comprises means for defining a second circuit model, said second circuit model comprising a topology having at least one circuit component, said topology being the same as, or equivalent to, the topology of a circuit model of said first environment. Said at least one circuit component of said second circuit model may conveniently be assigned a value that is the negated value of the corresponding circuit component of said circuit model of said first environment.

In the preferred embodiment, said parameter set is incorporated into said second circuit model as a circuit component, the arrangement being such that the combined topology of said second circuit model and the parameter set circuit component is the same as the topology of a circuit model of said first environment incorporating said circuit element.

Said first environment may comprise a first substrate in or on which said circuit element is mounted in order to measure the performance of said circuit element.

In one embodiment, the component includes means for modelling a transmission line, or transmission length or element, at the input of the circuit element model and/or means for modelling a transmission line, or transmission length or element, at the output of the circuit element model and/or means for modelling a transmission line gap in parallel with the parameter set component of the circuit element model topology. Advantageously, said transmission line/gap modelling means includes at least one user settable parameter for defining at least one characteristic of a second environment in which said circuit element is desired to be modelled. In particular, said at least user settable parameter defines one or more characteristics of a substrate on which said circuit element is to be mounted during use.

In one embodiment, the component may further include means for modelling a DC feed component in parallel with the parameter set component of the circuit element model topology.

A second aspect of the invention provides a component for a simulation tool, the component comprising means for defining a first model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment, said component further comprising means for defining a second model of said circuit element; and means for defining a switch for selecting one or other of said first and second defining means.

Preferably, said switch defining means causes one or other of said first and second defining means to be selected depending on the operational frequency of a circuit model in which said component is incorporated during use.

A third aspect of the invention provides a method of modelling a circuit element, the method comprising creating a set of performance parameters for said circuit element by measuring the performance of said circuit element in a first environment; creating a circuit model of said circuit element, said circuit model including a component comprised of said performance parameters, and means for negating the effect on said parameter set of said first environment.

A fourth aspect of the invention provides a computer program product comprising means for defining a model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment.

During use, a user may provide, as input parameters to the component, data relating to, or characterising, the environment in which the simulation is to take place. Typically, the environment comprises a substrate on or in which the component is provided. In such cases, the input data typically includes one or more of the following: the dielectric constant of the substrate; the height of the simulated circuit element above the ground plane (typically the height or thickness of the substrate); conductor loss; and/or substrate loss tangent.

The simulation tool component may take any suitable form, e.g. a Netlist or an HDL (Hardware Description Language) module, and comprises means for describing or defining a circuit model and may be synthesised, or otherwise utilised, by the simulation tool for use in simulations.

The preferred embodiment of the invention described hereinafter relates to the modelling of inductor components and in particular relates to a high frequency equivalent circuit model. It will be understood, however, that circuit models embodying the invention are not limited to modelling high frequency component operation and can be used for modelling component behaviour across all frequencies as well as d.c. (direct current) operation. The preferred equivalent circuit model may be used in all standard RF/microwave simulation tools and so helps a designer to accurately predict the performance of a circuit before building the circuit. In effect, the preferred model shows the non-ideal behaviour of the inductor (or other component) at higher operational frequencies (typically frequencies above the first resonance frequency of the relevant application), while maintaining the ideal characteristics at low operational frequencies (typically frequencies up to the first resonance).

In addition, the invention is not limited to modelling inductors, and may be used to model any other circuit elements or components, including passive components and active components, for example resistors, capacitors, transistors, diodes, filters or amplifiers. In general, the invention may be used in any area where a model is required or where simulations of circuits are performed.

The invention is particularly suited to modelling components that, in use, are mounted on a substrate, typically a substrate comprising dielectric material. However, the invention may also be used where the component is, during use, provided in a substrate (e.g. in a multi-layer substrate) or in any other environment.

Further advantageous aspects of the invention will become apparent to those skilled in the art upon review of the following description of a specific embodiment and with reference to the accompanying drawings.

### BRIEF DESCRIPTION OF DRAWINGS

An embodiment of the invention is now described by way of example and with reference to the accompanying drawings in which:

FIG. 1 shows a schematic diagram of a simple, conventional intrinsic inductor equivalent circuit model;

FIG. 2 shows a graph illustrating transmission coefficients against frequency for different substrate or dielectric materials.

FIG. 3 shows a schematic diagram of a conventional equivalent circuit model including the intrinsic model of FIG. 1 with additional components added to compensate for the effects of the substrate;

FIG. 4 shows a graph illustrating transmission coefficients against frequency and showing higher order resonance effects;

FIG. 5 shows a schematic diagram of an improved equivalent circuit model accounting for some higher order resonances;

FIG. 6 shows a graph illustrating insertion loss against frequency and shows the effectiveness of the improved equivalent circuit model of FIG. 5;

FIG. 7 shows a schematic diagram of an equivalent circuit model that may be used to create a component embodying a first aspect of the invention;

FIG. 8 shows a representation of a circuit gap for receiving a circuit component and a high frequency equivalent circuit model for the circuit gap;

FIG. 9 shows a graph illustrating transmission coefficients against frequency and shows the predicted frequency response of the model of FIG. 7 in comparison with an actual, or measured frequency response;

FIG. 10 shows an embodiment of a second aspect of the invention in which the component of the first aspect of the invention is provided in parallel with a conventional model; and

FIG. 11 shows an alternative embodiment of the circuit model of FIG. 7.

### DETAILED DESCRIPTION OF THE DRAWINGS

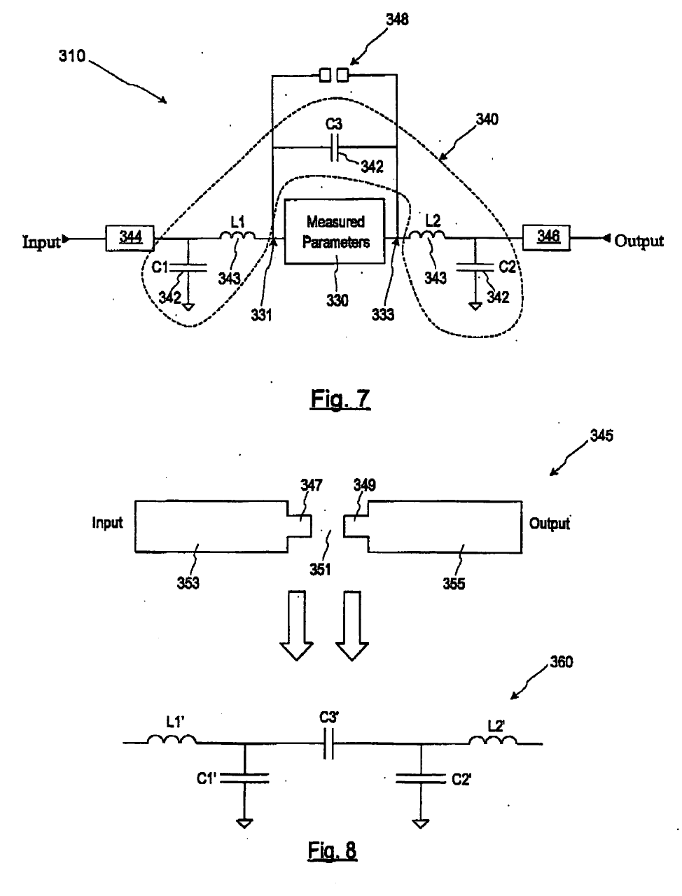

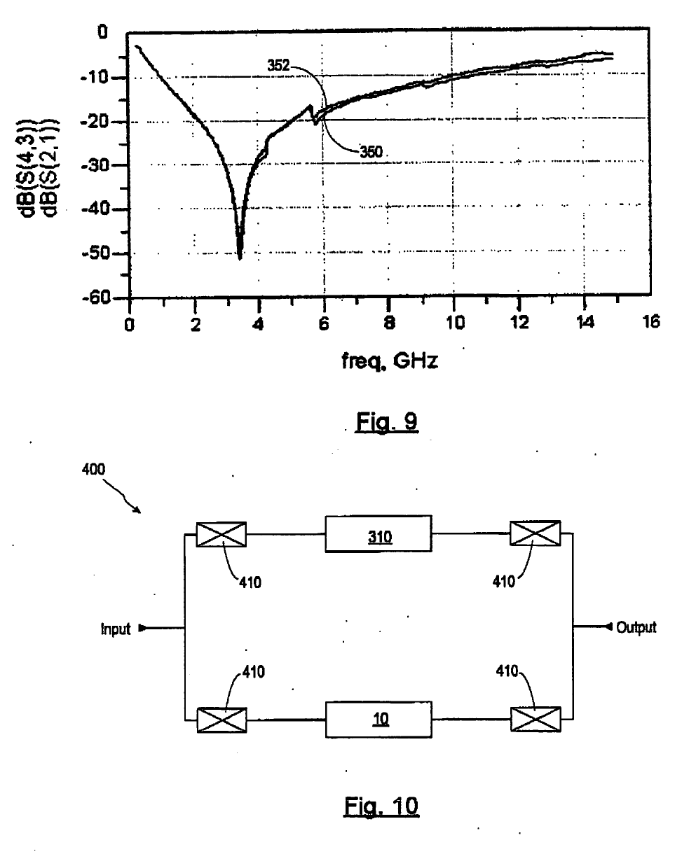

Referring now to FIG. 7, there is shown, generally indicated as 310, an equivalent circuit model 310 for a circuit element, or component. In the example of FIG. 7, the circuit element modelled by the model 310 is an inductor. The model 310 includes a component 330 representing the circuit element being modelled. The component 330 comprises a description or definition of the circuit element that defines how the circuit element behaves over a range of frequencies, and is advantageously derived from measurements of the circuit element's performance in a test or reference environment. In the preferred embodiment, the component 330 comprises a set of scattering parameters, or S-parameters, although, in alternative embodiments, any parameters that define or describe the operation of the component over a range of frequencies may be used. Typically, such parameters are measured parameters, the measurement being taken from a sample component in a test, or reference, environment. The S-parameters may be determined by measurement, for example by placing an actual sample of the inductor (or other circuit element) in a test, or measurement, environment, typically on a test, or measurement, substrate, and measuring the performance of the inductor over a range of frequencies. FIG. 8 shows a representation of a test environment generally indicated as 345. In FIG. 8, the test environment is assumed by way of illustration to comprise a substrate (not shown) on which there is provided two mounting pads 347, 349 between which is defined a gap 351. The pads 347, 349 are typically provided at an end of a respective length of transmission line 353, 355, in which case the gap 351 may be referred to as a transmission line gap. In the present example, the transmission lines 353, 355 are assumed to comprise microstrip lines and so the gap 351 may be referred to as a microstrip gap.

The measured S-parameters are affected by the characteristics, especially the electrical characteristics such as parasitic capacitances and inductances, of the test substrate. In order to compensate for this, a network 340 of model components is included in the model 310. Typically, the network 340 comprises components representing capacitors (or capacitances) 342 and inductors (or inductances) 343. The network 340 exhibits a topology that represents the characteristics of the test environment 345, which in the present example means the characteristics of the test substrate on which the measured component was mounted during measurement. FIG. 8 shows an equivalent circuit model, generally indicated at 360, representing the test environment 345. In the preferred embodiment, the topology of the network 340 is dependent on the topology of the circuit model 360 and is configured to negate the effect that the environment 345, as represented by model 360, had on the measured parameters. To this end, in the preferred embodiment, the network 340 includes, in respective of each component of the network 360, at least one component that is positioned within the topology of network 340, and given a respective component value, such that the effect of the respective network 360 component is negated. Typically, the network 360 is comprised of capacitors/capacitances and inductors/inductances. Conveniently, the network 340 includes, in respect of each component of the network 360 (or other environment network), a respective component of the same type (e.g. a capacitance or inductance) having a value that is the negative of the value of the respective network 360 component, and which is positioned in the network 340 to negate the effect of the respective network 360 component. For example, network 360 may be considered to exist (in terms of its effect on the measured parameters of component 330) between the input 331 and output 333 of component 330. Hence, inductor L1′ would be present in series with input 331. To negate the effect of inductance L1′ of network 360, network 340 includes an inductor L1 having a value that is the negative of the value of inductance L1′ and which is positioned at the input 331 of component 330 in series. Once the effect of L1′ is negated, other components can be added to the network 340 to negate the effects of other components of network 360. For example shunt capacitor C1 is added to negate the effect of shunt capacitor C1′. Conveniently, the network 340 may be constructed component-by-component starting at the input 331 and output 333 of the component 330. It will be seen by comparison of the networks 240, 360, that the relative positions of shunt capacitor C1 and series inductor L1 are swapped with respect to the relative positions of C1′ and L1′. Similarly for C2, L2 and C2′, L2′. The network 340 may be said to comprise the inverse of the network 360.

In the model 310, the component 330 representing the circuit element being modelled is associated with the network 340 in a manner that represents the circuit element being provided in the test environment 345, which, in the present example, means mounted on a substrate via the mounting pads 347, 349 and across the gap 351.

In the present example, network 340 comprises a series inductance (or inductor) L1 having one terminal or end connected to the input 331 of model component 330, and a shunt capacitance (or capacitor) C1 connected between the other end or terminal of inductance L1 and electrical ground. The network 340 further includes a series inductance (or inductor) L2 having one terminal or end connected to the output 333 of model component 330, and a shunt capacitance (or capacitor) C2 connected between the other end or terminal of inductance L2 and electrical ground. A capacitance (or capacitor) is provided in parallel across the model component 330. The topology 360 of the test substrate is the inverse of the topology of network 340, as described above, the respective components being labelled L1′, C1′, L2′, C2′ and C3′ in FIG. 8. It will be understood that alternative topologies for the network 340 and 360 may be used.

Using conventional modelling packages for a given test substrate of known characteristics, the component values for the circuit model 360, i.e. the values of L1′, C1′, L2′, C2′ and C3′, can be calculated. The calculations are performed for the test substrate 345 itself, i.e. in the absence of the inductor, or other circuit element, being modelled. By way of example, for a duroid PTFE substrate of dielectric constant 2.2 and thickness 0.254 mm, suitable component values may be as follows: L1′=0.202nH; C1′=0.0556pF; L2′=0.202nH; C2′=0.0556pF; C3′=0.004pF. In the illustrated example, the value of L1′ is the same as the value of L2′, and the value of C1′ is the same as the value of C2′.

The components of the network 340, in this case the capacitance and inductance components 342, 343, are each assigned the respective negative value of the corresponding component in the network 360. Hence, L1=−L1′, C1=−C1′, L2=−L2′, C2=−C2′, C3=−C3′. As a result, the network 340 has the effect, during simulations, of negating the effect that the test substrate 345 has on the measured characteristics of model component 330, as defined in the preferred embodiment by S-parameters. Hence, the performance of the model 310 is independent of the characteristics of the test substrate .

Determining the component values for L1, C1, L2, C2 and C3 is the only fitting required to enable the model 310 to be used for simulations in which the circuit element being modelled is mounted on any substrate. The values for L1, C1, L2, C2 and C3 do not need to be recalculated for different substrates, i.e. the values for L1, C1, L2, C2 and C3 are independent of whatever substrate the inductor, or other circuit element, is mounted on.

The model 310 advantageously includes one or more model components representing the environment into which the circuit element being modelled is to be incorporated during use. In the present example, the model 310 includes a respective model component 344, 346, 348 for a first length of transmission line, e.g. microstrip line, (associated, in use, with the input of the circuit element), a second length of transmission line, e.g. microstrip line, (associated, in use, with the output of the circuit element), and a transmission line gap, e.g. microstrip gap, across which the element being modelled is to be mounted during use. In the preferred embodiment, the first transmission line model component 344 is provided in series between the input of the model 310 and the network 340, the second transmission line model component 346 is provided in series between the output of the model 310 and the network 340 and the transmission line gap model 348 is provided in parallel with the circuit component 330, i.e. across its inputs 331, 333. Conveniently, the transmission line component models 344, 346, 348 may comprise conventional transmission line or microstrip models. Such models may comprise well known equivalent circuit models whose topology and definitions are widely published.

In order to use the model 310, a designer need only set one or more parameters associated with the transmission line/gap models 344, 346, 348 and relating to the substrate on which the circuit element being modelled is to be mounted during use. The parameters may include one or more of the following: the dielectric constant of the substrate; the height of the simulated circuit element above the ground plane (typically the height or thickness of the substrate); conductor loss; and/or substrate loss tangent.

FIG. 9 shows an example predicted response 350 obtained from model 310 as well as an actual response 352. FIG. 9 illustrates the accuracy of the model 310, showing how model 310 predicts higher order resonances accurately. The model 310 may be modified to predict the behaviour of the inductor, or other circuit component, when mounted on any substrate simply by changing the substrate parameters of the microstrip components 344, 346, 348.

The model 310 can be used for modelling any substrate mounted component including chip inductors, capacitors or resistors of any size. More generally, the methods described herein can be applied to any component, whereby a measurement of the component's performance is taken in a test environment, the resulting performance model is de-embedded from the effects of the test environment and, during simulation, appropriate parameters for the proposed use environment are applied.

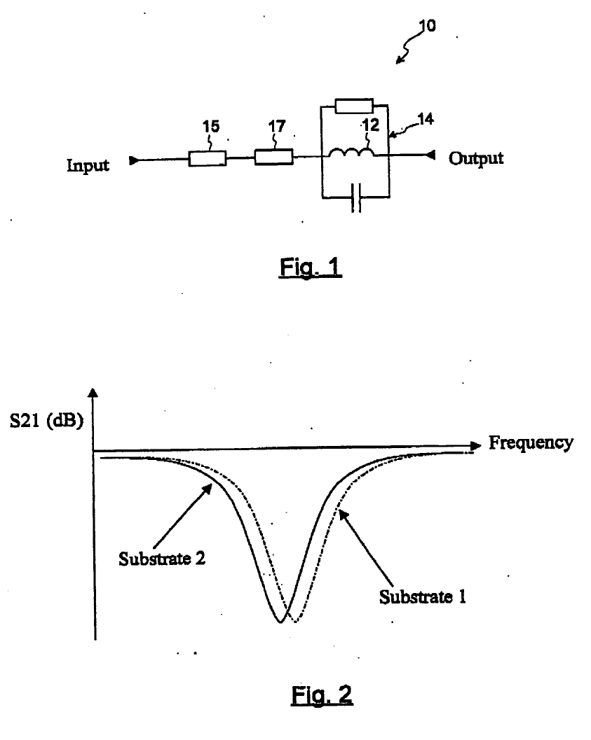

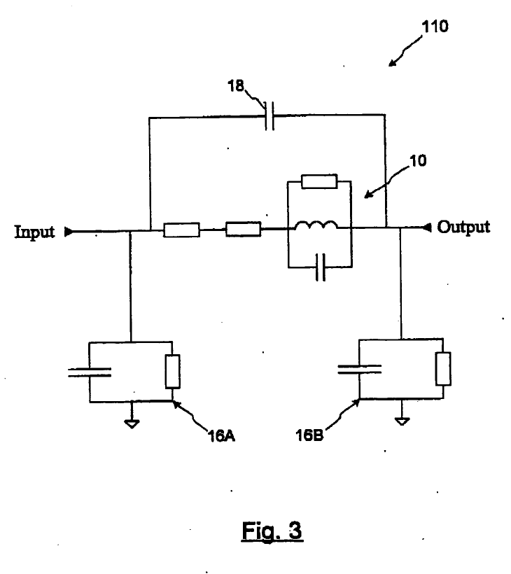

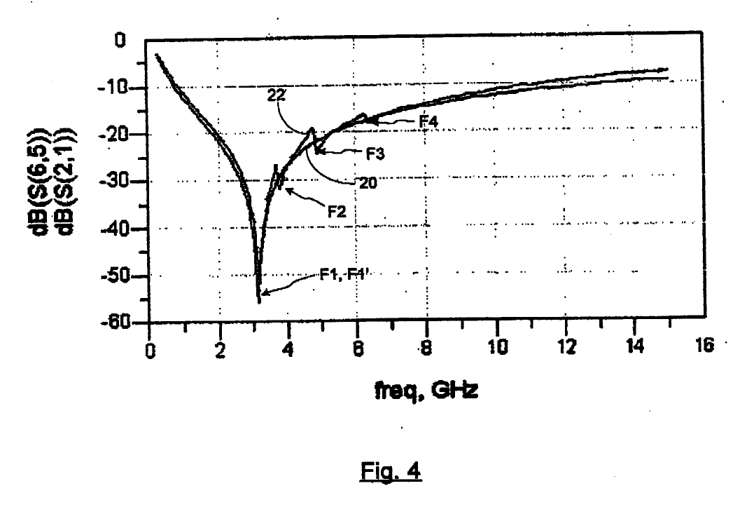

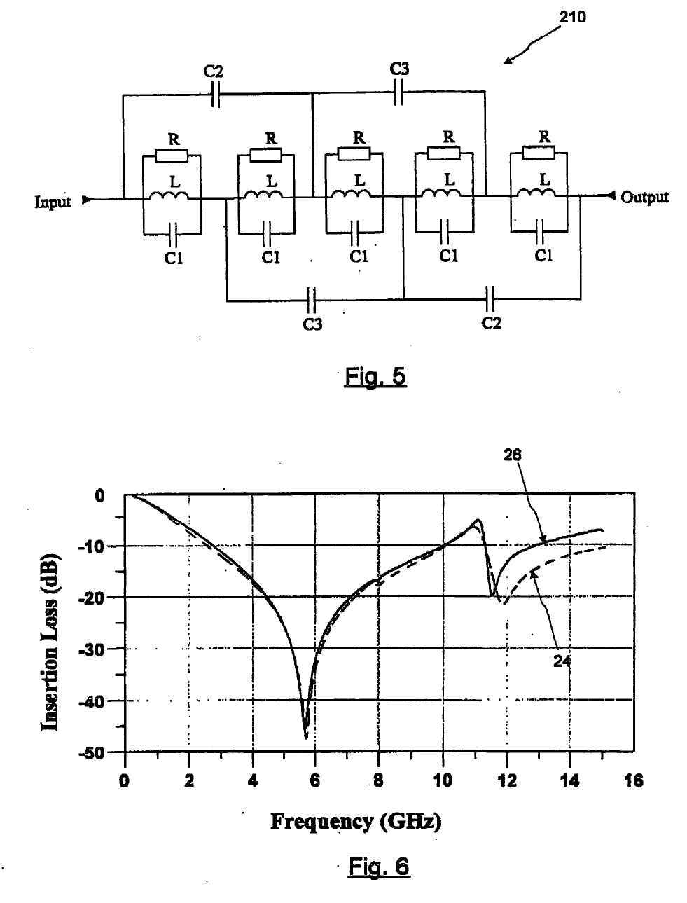

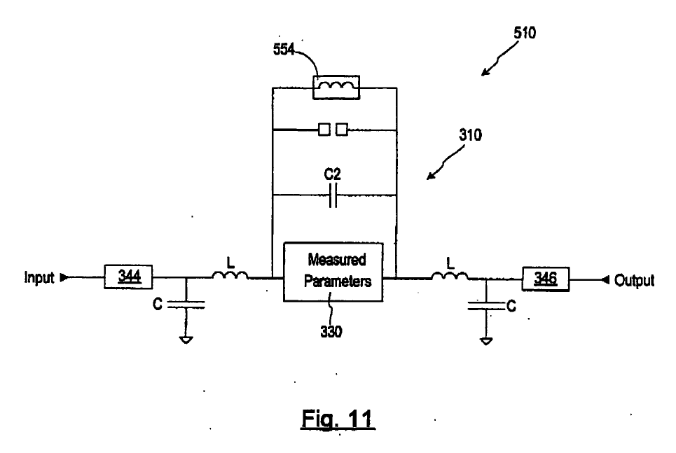

Referring to FIG. 10, a component model 400 may be provided in which a conventional equivalent circuit model (for example model 10 as shown in FIG. 1) is arranged in parallel with a model embodying the invention, for example model 310, and associated with one or more frequency switching means, in the form of, for example, a frequency dependent resistance 410. The arrangement is such that, depending on the operational frequency, one or other of the models 10, 310 is used to model a given circuit element. This may be used to prevent usage of the model embodying the invention outside its measured operational frequency range. In the preferred embodiment, a respective frequency switch is provided on either side of each model 10, 310 to ensure that the non-active model is isolated from the active model during use.

FIG. 11 shows an equivalent circuit model, generally indicated as 510, that is generally similar to the model 310 described above and to which similar descriptions apply. The model 510 further includes a dc feed, e.g. high inductance, element 554 in parallel with the model component 330. This allows the performance of the element being modelled to be modelled correctly with dc operating signals and allows the use of ‘Harmonic Balance Simulations’.

Equivalent circuit models embodying the invention may advantageously be used to provide a component for a simulation tool. The simulation tool component may take any suitable form, e.g. a Netlist or an HDL (Hardware Description Language) module, which describes or defines the equivalent circuit model (for example the model 310, 400 or 510) and which may be used by a simulation tool during simulation. Typically, the simulation component is synthesised by the simulation tool into a suitable form for use in simulations. A user of the simulation tool may select the component from, for example, a library of simulation tool components, and incorporate it into a simulation circuit as required, having set the or each parameter that is required to customise the component for the target substrate or environment.

It will be apparent from the foregoing that the invention in its preferred form provides a measurement based component model wherein the main model component comprises a set of measured S-parameters (or other performance indicating parameters); and wherein the measured S-parameters (or other parameters) are de-embedded from their measurement, or test, surroundings, i.e. the model includes means for negating the effects of the characteristics of the measurement or test substrate, or other environment. The model is preferably a substrate based type.

The invention may, for example, be used in any RF circuit where chip inductors are used. However, the invention may also be employed in relation to any electrical or electronic component, or to any modelling application.

Component models embodying the invention can provide the following advantages over conventional component models: accurate prediction of circuit performance at high frequencies; circuit performance prediction on any mounting material or substrate - not just a limited number of pre-modelled materials; reduction in the number of required measurements and overall model fits; reduced complexity of the overall component model.

In the preferred embodiment, the equivalent circuit model, or component model, is based on a single behavioural measurement over frequency (e.g. S-parameters), and the results of this measurement provide the basis of the model. Different ideal elements (e.g. microstrip lines/gaps) are added around the measured model component (e.g. component 330) to model how component behaviour changes due to different substrates.

The following advantages are obtained: multi-resonant points are easily predicted; the need for measurements on all types of substrate is removed; the need for individual element curve fitting is removed; High Frequency models can be produced very quickly. The invention is not limited to the embodiment described herein which may be modified or varied without departing from the scope of the invention.

1. A component for a simulation tool, the component comprising means for defining a model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment.

2. A component as claimed in claim 1, wherein said circuit element model comprises a topology of circuit components, said parameter set serving as a component of said circuit model topology.

3. A component as claimed in claim 1, wherein said negating means comprises means for defining a second circuit model, said second circuit model comprising a topology having at least one circuit component, said topology being derived from the topology of a circuit model of said first environment.

4. A component as claimed in claim 3, wherein said first environment circuit topology includes at least one circuit component, said second circuit model including, in respect of said at least one circuit component of the environment circuit topology, at least one corresponding circuit component arranged to negate the effect of the respective at least one circuit component of the environment circuit topology.

5. A component as claimed in claim 4, wherein said at least one circuit component of said second circuit model is assigned a value that is the negated value of a corresponding circuit component of said circuit model of said first environment.

6. A component as claimed in claim 3, wherein said parameter set is incorporated into said second circuit model as a circuit component, the arrangement being such that said second circuit model negates the effect on said parameter set of said circuit model of said first environment.

7. A component as claimed in claim 1, wherein said first environment comprises a first substrate on which said circuit element is mounted in order to measure the performance of said circuit element.

8. A component as claimed in claim 1, including means for modelling a transmission line at the input of the circuit element model.

9. A component as claimed in claim 8, wherein said transmission line modelling means includes at least one user settable parameter for defining at least one characteristic of a second environment in which said circuit element is desired to be modelled.

10. A component as claimed in claim 1, including means for modelling a transmission line at the output of the circuit element model.

11. A component as claimed in claim 10, wherein said transmission line modelling means includes at least one user settable parameter for defining at least one characteristic of a second environment in which said circuit element is desired to be modelled.

12. A component as claimed in claim 2, including means for modelling a transmission line gap in parallel with the parameter set component of the circuit element model topology.

13. A component as claimed in claim 12, wherein said transmission line gap modelling means includes at least one user settable parameter for defining at least one characteristic of a second environment in which said circuit element is desired to be modelled.

14. A component as claimed in claim 2, further including means for modelling a DC feed component in parallel with the parameter set component of the circuit element model topology.

15. A component as claimed in claim 1, wherein said parameter set comprises S-parameters.

16. A component for a simulation tool, the component comprising means for defining a first model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment, said component further comprising means for defining a second model of said circuit element; and means for defining a switch for selecting one or other of said first and second defining means.

17. A component as claimed in claim 16, wherein said switch defining means causes one or other of said first and second defining means to be selected depending on the operational frequency of a circuit model in which said component is incorporated during use.

18. A method of modelling a circuit element, the method comprising creating a set of performance parameters for said circuit element by measuring the performance of said circuit element in a first environment; creating a circuit model of said circuit element, said circuit model including a component comprised of said performance parameters, and means for negating the effect on said parameter set of said first environment.

19. A computer program product comprising means for defining a model of a circuit element, said defining means including a set of parameters that define the performance of the circuit element over a range of frequencies, wherein said parameter set is derived from the performance of said circuit element in a first environment, said defining means further including means for negating the effect on said parameter set of said first environment.
